(19) United States
(12) Patent Application Publication
(10) Pub. No.: US 2026/0320116 A1
(43) Pub. Date: Oct. 15, 2026

(54) DATA SYSTEM, IDENTIFICATION DEVICE, DATA SYSTEM CONTROL METHOD, AND STORAGE MEDIUM

(71) Applicant: JVCKENWOOD Corporation, Yokohama-shi (JP)

(72) Inventor: Mayo Iiyama, Yokohama-shi (JP)

(21) Appl. No.: 19/690,080

(22) Filed: May 28, 2026

Related U.S. Application Data
(63) Continuation of application No. PCT/JP2024/035561, filed on Oct. 4, 2024.

(30) Foreign Application Priority Data
Dec. 22, 2023 (JP) 2023-216747

(51) Int. Cl. G06F 16/683

(52) U.S. Cl. CPC G06F 16/683

(57) ABSTRACT

Creators of pieces of content are to be identified. A data system includes: an acquisition unit that acquires a piece of target content to be combined into a piece of composite content in which a plurality of pieces of content that are music data have been hierarchically combined; a data generation unit that generates unique data that are audio data for identifying a creator of the piece of target content; and a data combination unit that superimposes the unique data on the piece of target content in correspondence with a layer of the piece of target content for combination of the piece of target content into the piece of composite content.

### CROSS-REFERENCE TO RELATED APPLICATIONS

This application is a Continuation of PCT International Application No. PCT/JP2024/035561 filed on Oct. 4, 2024 which claims the benefit of priority from Japanese Patent Application No. 2023-216747, filed on Dec. 22, 2023, the entire contents of both of which are incorporated herein by reference.

### BACKGROUND OF THE INVENTION

### 1. Field of the Invention

The present disclosure relates to a data system, an identification device, a data system control method, and a program.

### 2. Description of the Related Art

A service, in which a plurality of artists join and which enables creation of composite content by combining content created by each artist, has been provided. For example, a service provider server is disclosed in Japanese Unexamined Patent Application Publication No. 2012-118776. This service provider server enables users to freely buy and sell content produced by themselves, enables exchanges between users through feedback on the content from buyer users, and enables free buying and selling of derivative content derived from the content within the site to allow the content to grow.

However, in such a service, there is a risk that content created by others may be copied by a user without permission and uploaded as content created by the user. Therefore, there is a demand for identification of the creator of each content that is combined when composite content is created.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A data system according to the present disclosure, comprising:
an acquisition unit that acquires a piece of target content to be combined into a piece of composite content in which a plurality of pieces of content that are music data have been hierarchically combined;
a data generation unit that generates unique data that are audio data for identifying a creator of the piece of target content; and
a data combination unit that superimposes the unique data on the piece of target content in correspondence with a layer of the piece of target content for combination of the piece of target content into the piece of composite content.

An identification device according to the present disclosure, comprising: an acquisition unit that acquires the piece of composite content generated by the data system; an extraction unit that extracts the unique data of the piece of content included in the piece of composite content, from the piece of composite content acquired; and
an analysis unit that identifies creator information of the piece of content from the unique data extracted.

A data system control method according to the present disclosure, including: a step of acquiring a piece of target content to be combined into a piece of composite content in which a plurality of pieces of content that are music data have been hierarchically combined; a step of generating unique data that are audio data for identifying a creator of the piece of target content; and a step of superimposing the unique data on the piece of target content in correspondence with a layer of the piece of target content for combination of the piece of target content into the piece of composite content.

A non-transitory computer-readable storage medium storing a program causing a computer according to the present disclosure to execute: a step of acquiring a piece of target content to be combined into a piece of composite content in which a plurality of pieces of content that are music data have been hierarchically combined; a step of generating unique data that are audio data for identifying a creator of the piece of target content; and a step of superimposing the unique data on the piece of target content in correspondence with a layer of the piece of target content for combination of the piece of target content into the piece of composite content.

### BRIEF DESCRIPTION OF THE DRAWINGS

FIG. 1 is a schematic diagram of a data system according to a first embodiment;

FIG. 2 is a schematic block diagram of a user terminal according to the first embodiment;

FIG. 3 is a schematic block diagram of a management apparatus according to the first embodiment;

FIG. 4 is a tree diagram illustrating an example of pieces of composite content;

FIG. 5 is a graph illustrating an example of unique data;

FIG. 6 is a schematic diagram illustrating an example of a method of superimposing unique data;

FIG. 7 is a schematic diagram illustrating another example of the method of superimposing unique data;

FIG. 8 is a flowchart illustrating a processing flow of the management apparatus according to the first embodiment;

FIG. 9 is a schematic diagram of a data system according to a second embodiment; and

FIG. 10 is a schematic block diagram of an identification device according to the second embodiment.

### DETAILED DESCRIPTION OF THE PREFERRED EMBODIMENTS

Preferred embodiments of the present disclosure will be described in detail hereinafter by reference to the appended drawings. The present disclosure is not to be limited to these embodiments and in a case where there are a plurality of embodiments, those configured by combining the embodiments are also included.

### First Embodiment

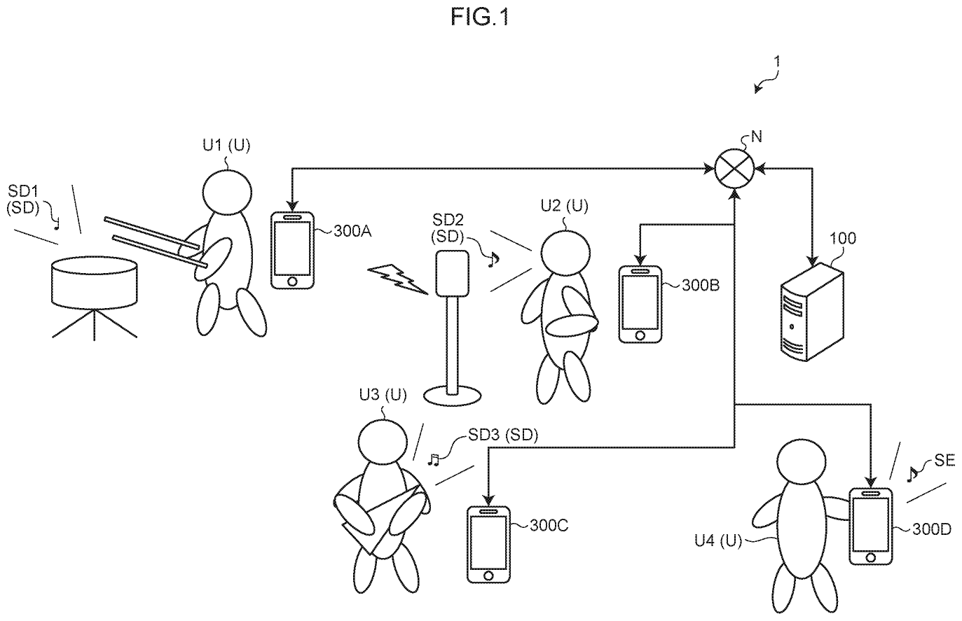

A configuration of a data system 1 will be described using FIG. 1. FIG. 1 is a schematic diagram of a data system according to a first embodiment.

### Configuration of Data System

The data system 1 according to the first embodiment and illustrated in FIG. 1 includes: a management apparatus 100 that generates a piece of composite content; and user terminals 300 that acquire pieces of content created by users. The management apparatus 100 and the user terminals 300 are in communication with each other via a network N. These components will be briefly described hereinafter.

### Management Apparatus

The management apparatus 100 executes, for example, processing on the basis of information transmitted from the user terminals 300 via the network N. The management apparatus 100 may be implemented by an information processing apparatus, such as a computer including functions of, for example, a personal computer (PC), a workstation (WS), or a server.

### User Terminal

The user terminals 300 are information processing devices used by the users. The user terminals 300 may each be, for example, an information processing device, such as a smartphone, a tablet terminal, a wearable terminal, a mobile phone, or a personal digital assistant (PDA). FIG. 1 illustrates an example of a case where the user terminals 300 are smartphones.

The network N connects the management apparatus 100 and the user terminals 300 to each other so as to enable wired or wireless communication therebetween. In a case where the network N is wired, the network N may be implemented by ETHERNET (registered trademark) specified in IEEE 802.3. In a case where the network N is wireless, the network N may be implemented by a wireless local area network (LAN) specified in IEEE 802.11 or Bluetooth (registered trademark).

### Overview of Data System

The data system 1 is a system that generates a piece of composite content SE by superimposing a plurality of pieces of content SD. The pieces of content SD are audio data and the piece of composite content SE is music data generated by combining the different pieces of content SD. In this embodiment, the user terminals 300 acquire the pieces of content SD and transmit the pieces of content SD to the management apparatus 100 via the network N. In this embodiment, the management apparatus 100 combines the respective pieces of content SD transmitted from the user terminals 300 to generate the piece of composite content SE. As to formats of the audio data, for example, the audio data may be audio source data in formats, such as RIFF waveform Audio Format (WAV) and MPEG-1 Audio Layer-3 (MP3), but are not limited thereto.

FIG. 1 illustrates an example in which a terminal 300A of a user U1 acquires a piece of content SD1 of a drum performance by the user U1, a user terminal 300B of a user U2 acquires a piece of content SD2 of a singing voice of the user U2, and a user terminal 300C of a user U3 acquires a piece of content SD3 of a guitar performance by the user U3. In the example of FIG. 1, the user terminals 300A, 300B, and 300C transmit the pieces of content SD1, SD2, and SD3 to the management apparatus 100 via the network N. In the example of FIG. 1, the management apparatus 100 superimposes the pieces of content SD1, SD2, and SD3 acquired from the user terminals 300A, 300B, and 300C to generate a new piece of composite content SE. The management apparatus 100 may distribute the piece of composite content SE to a user terminal 300D and cause the user terminal 300D to output the piece of composite content SE, on the basis of, for example, a request from the user terminal 300D of a user U4. The piece of composite content SE is not necessarily generated by the management apparatus 100, and may be generated by a user terminal 300. That is, for example, a user terminal 300 may acquire the pieces of content SD stored in the management apparatus 100 to generate the piece of composite content SE, and the management apparatus 100 may acquire the piece of composite content SE generated by the user terminal 300. The management apparatus 100 may then distribute the piece of composite content SE to the user terminals 300A, 300B, 300C, and/or 300D. When a plurality of users are not distinguished from one another, they will be referred to as users U hereinafter.

### Configuration of User Terminal

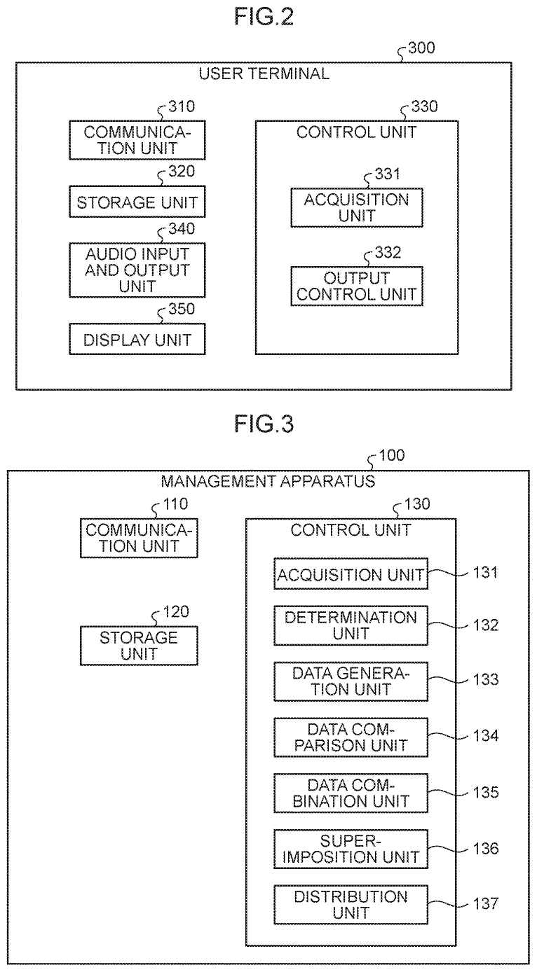

FIG. 2 is a schematic block diagram of a user terminal according to the first embodiment. As illustrated in FIG. 2, the user terminals 300 according to the present disclosure each include a communication unit 310, a storage unit 320, a control unit 330, an audio input and output unit 340, and a display unit 350.

### Communication Unit

The communication unit 310 is a communication module through which the user terminal 300 communicates with an external device. The communication unit 310 transmits and receives various data to and from the external device via wireless communication or wired communication. In the case of wireless communication, the communication unit 310 may include communication processing circuitry, such as a communication antenna, a radio frequency (RF) circuit, and/or a wireless local area network (LAN) card. In the case of wired communication, for example, the communication unit 310 may include a network interface card (NIC) equipped with a wired LAN terminal, a transmission circuit, and/or other communication processing circuitry.

### Storage Unit

The storage unit 320 is a storage device that stores various information. The storage unit 320 includes a main storage device and an auxiliary storage device. The main storage device may be implemented by, for example, a semiconductor memory element, such as a random access memory (RAM), a read only memory (ROM), or a flash memory. The auxiliary storage device may be implemented by, for example, a hard disk, a solid state drive (SSD), or an optical disk.

### Audio Input and Output Unit

The audio input and output unit 340 inputs and outputs various audio. That is, the audio input and output unit 340 has a microphone function and a speaker function. For example, the audio input and output unit 340 may output audio of a piece of content. The audio input and output unit 340 may receive input of voice or sound of a musical instrument performance, through a microphone.

### Display Unit

The display unit 350 displays various information. For example, the display unit 350 may display a graphical user interface (GUI) for executing various processing of the user terminal 300. The display unit 350 may be implemented by a liquid crystal display, an organic electroluminescence (EL) display, or a micro light emitting diode (LED) display.

### Control Unit

The control unit 330 is a controller that governs and controls the user terminal 300. The control unit 330 is implemented by, for example, a central processing unit (CPU) or a microprocessing unit (MPU) executing various programs stored in a storage unit 320, with a RAM serving as a work area. The control unit 330 may be implemented by, for example, an integrated circuit, such as an application specific integrated circuit (ASIC) or a field programmable gate array (FPGA).

As illustrated in FIG. 2, the control unit 330 includes an acquisition unit 331 and an output control unit 332. By reading and executing programs (software) from the storage unit 320, the control unit 330 implements their functions and executes processing thereof. These functions of the control unit 330 may be implemented by electronic circuits. The control unit 330 may execute the processing by means of a single CPU, or may include a plurality of CPUs and the plurality of CPUs may execute the processing in parallel.

### Processing of User Terminal

The acquisition unit 331 acquires a piece of content SD. The acquisition unit 331 may acquire the piece of content SD by any method. For example, the acquisition unit 331 may acquire audio data input via the audio input and output unit 340 as the piece of content SD. Furthermore, for example, the acquisition unit 331 may acquire a piece of content SD from another device (for example, the management apparatus 100), via the communication unit 310.

The output control unit 332 transmits the piece of content SD acquired by the acquisition unit 331 to the management apparatus 100 via the communication unit 310. In this embodiment, the output control unit 332 transmits user information indicating a user U of the user terminal 300, in association with the piece of content SD, to the management apparatus 100. The user information may be said to be information indicating the user U who transmits the piece of content SD. In this embodiment, the output control unit 332 transmits, in association with the piece of content SD, combining destination information indicating a piece of composite content SE or one piece of content SD with which the piece of content SD is to be combined, to the management apparatus 100. The combining destination information is information indicating with which piece of composite content SE or one piece of content SD the transmitted piece of content SD is to be combined. The piece of composite content SE or the one piece of content SD with which the piece of content SD is to be combined will be referred to as content data as appropriate hereinafter.

The output control unit 332 may remove audio data in a non-audible frequency band from the piece of content SD acquired by the acquisition unit 331 and transmit, to the management apparatus 100, the piece of content SD from which the audio data in the non-audible frequency band have been removed. Determination of whether unique data 20 described later are included is thereby able to be executed accurately. The non-audible frequency band corresponds to, for example, frequencies of less than 20 Hz or greater than 20 kHz. The audio data in the non-audible frequency band may be removed by any method. For example, any filter, such as a low-pass filter may be used.

### Configuration of Management Apparatus

FIG. 3 is a schematic block diagram of a management apparatus according to the first embodiment. As illustrated in FIG. 3, the management apparatus 100 according to the present disclosure includes a communication unit 110, a storage unit 120, and a control unit 130.

### Communication Unit

The communication unit 110 is a communication module through which the management apparatus 100 communicates with an external device. The communication unit 110 transmits and receives various data to and from the external device via wireless communication or wired communication. In the case of wireless communication, the communication unit 110 may include communication processing circuitry, such as a communication antenna, an RF circuit, and/or a wireless LAN card. In the case of wired communication, for example, the communication unit 110 may include an NIC equipped with a wired LAN terminal, a transmission circuit, and/or other communication processing circuitry.

### Storage Unit

The storage unit 120 is a storage device that stores various information. The storage unit 120 includes a main storage device and an auxiliary storage device. The main storage device may be implemented by, for example, a semiconductor memory element, such as a RAM, a ROM, or a flash memory. The auxiliary storage device may be implemented by, for example, a hard disk, an SSD, or an optical disk.

### Control Unit

The control unit 130 is a controller that governs and controls the management apparatus 100. The control unit 130 is implemented by, for example, a CPU or an MPU executing various programs stored in the storage unit 120, with a RAM serving as a work area. The control unit 130 may be implemented by, for example, an integrated circuit, such as an ASIC or an FPGA.

As illustrated in FIG. 3, the control unit 130 includes an acquisition unit 131, a determination unit 132, a data generation unit 133, a data comparison unit 134, a data combination unit 135, a superimposition unit 136, and a distribution unit 137. By reading and executing programs (software) from the storage unit 120, the control unit 130 implements their functions and executes processing thereof. These functions of the control unit 130 may be implemented by electronic circuits. The control unit 130 may execute the processing by means of a single CPU, or may include a plurality of CPUs and the plurality of CPUs may execute the processing in parallel.

The acquisition unit 131 acquires a piece of content SD (a piece of target content) from a user terminal 300, the determination unit 132 determines whether unique data 20 (described later) are included in the piece of content SD, the data generation unit 133 generates unique data 20 of the piece of content SD, the data comparison unit 134 determines whether to permit combination of the piece of content SD into a piece of composite content SE, the data combination unit 135 superimposes the unique data 20 on the piece of content SD in correspondence with a layer L (described later) of the piece of content SD, the superimposition unit 136 generates the piece of composite content SE by combining the piece of content SD, and the distribution unit 137 outputs the piece of composite content SE. Specific processing of each of these units will be described later.

In this embodiment, the management apparatus 100 includes the determination unit 132, the data generation unit 133, the data comparison unit 134, and the data combination unit 135, and performs the processing of generating unique data 20, superimposing the unique data 20 on a piece of content SD, and determining whether to permit combination of the piece of content SD. However, this processing is not necessarily executed by the management apparatus 100, and a user terminal 300 may execute at least part of the processing. That is, for example, a user terminal 300 may include at least one of the determination unit 132, the data generation unit 133, the data comparison unit 134, and the data combination unit 135, and execute the processing thereof.

### Composite Content

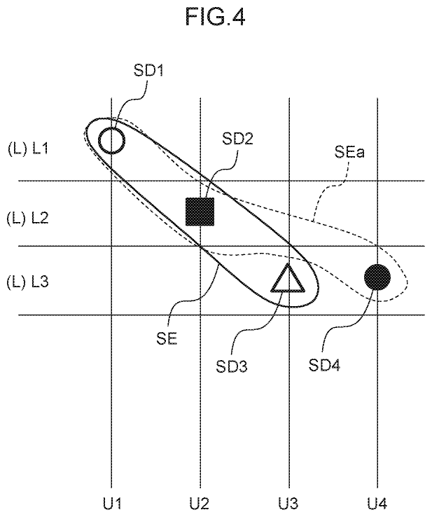

A specific example of pieces of composite content will be described hereinafter. FIG. 4 is a tree diagram illustrating an example of pieces of composite content.

The acquisition unit 131 acquires pieces of content SD from the user terminals 300. As described above, in this embodiment, because user information and combining destination information are also transmitted with pieces of content SD, the acquisition unit 131 acquires the pieces of content SD, user information indicating the users U of the user terminals 300, and combining destination information indicating content data (pieces of composite content with which the pieces of content SD are to be combined).

The superimposition unit 136 generates a piece of composite content SE by superimposing a plurality of pieces of content SD. For example, the superimposition unit 136 generates a piece of composite content SE by superimposing a piece of content SD acquired by the acquisition unit 131 on content data (a piece of composite content SE with which the piece of content SD is to be combined) indicated by combining destination information. That is, the superimposition unit 136 generates a piece of composite content SE by superimposing a piece of content SD according to the order in which the piece of content SD was acquired (the order in which the piece of content SD was transmitted to the management apparatus 100). Hereinafter, the order in which the piece of content SD is combined within the piece of composite content SE will be referred to as a layer L, as appropriate. The piece of composite content SE generated is stored in the storage unit 120.

For example, FIG. 4 illustrates an example in which the pieces of content SD1, SD2, and SD3 are acquired in this order. In this case, when the piece of content SD2 is acquired, the superimposition unit 136 combines the piece of content SD2 with the piece of content SD1, and generates a piece of composite content SE in which the pieces of content SD1 and SD2 have been combined. When the piece of content SD3 is acquired, the superimposition unit 136 combines the piece of content SD3 with the piece of composite content SE in which the pieces of content SD1 and SD2 have been combined, thereby generating a piece of composite content SE in which the pieces of content SD1, SD2, and SD3 have been combined. In this case, the layer L of the piece of content SD1 acquired first is a layer L1 (first), the layer L of the piece of content SD2 acquired next is a layer L2 (second), and the layer L of the piece of content SD3 acquired subsequently is a layer L3 (third).

A piece of content SD is able to be combined with any content data (a piece of composite content SE with which the piece of content SD is to be combined) according to combining destination information. For example, as illustrated in FIG. 4, a piece of content SD4 transmitted from the user terminal 300 of the user U4 may be superimposed on the piece of composite content SE in which the pieces of content SD1 and SD2 have been combined, to generate a piece of composite content SEa in which the pieces of content SD1, SD2, and SD4 have been combined. That is, a plurality of pieces of composite content SE may be generated in a tree diagram structure.

The distribution unit 137 distributes a piece of composite content SE generated by the superimposition unit 136 to a user terminal 300 via the communication unit 110.

A piece of composite content SE is generated by combining pieces of content SD transmitted from the user terminals 300, as described above. However, a piece of content SD acquired from another device may be transmitted from a user terminal 300. Therefore, even in a case where the creator of that piece of content SD is different from the user U of that user terminal 300, there is a risk that the creator of the piece of content SD may be mistakenly recognized as the user U of the user terminal 300. Therefore, for example, there is a risk that a piece of content SD created by another person may be copied by a user without permission and uploaded as a piece of content SD created by the user and then combined into a piece of composite content SE. In contrast, in this embodiment, unique data 20 indicating the creator of a piece of content SD are embedded in the piece of content SD, and on the basis of the unique data 20, whether or not the piece of content SD is permitted to be combined into a piece of composite content SE is determined. The piece of composite content SE is thereby able to be generated while reducing the likelihood of misrecognition of the creator of the piece of content SD. Specific processing thereof will be described hereinafter.

### Unique Data

In this embodiment, the data generation unit 133 generates unique data 20, and the data combination unit 135 embeds (superimposes) unique data 20 in (on) a piece of content SD in correspondence with the layer L of the piece of content SD (the order in which the piece of content SD was combined, assuming that the piece of content SD was combined). The unique data 20 are audio data. More specifically, the unique data 20 according to the embodiment are audio data having frequencies in a non-audible range. The frequencies of the unique data 20 are, for example, preferably less than 20 Hz or greater than 20 kHz. The data combination unit 135 generates unique data 20 different for each creator. For example, the data combination unit 135 sets the waveform of the unique data 20 differently for each creator. The creators of the pieces of content SD are thereby able to be identified by the unique data 20.

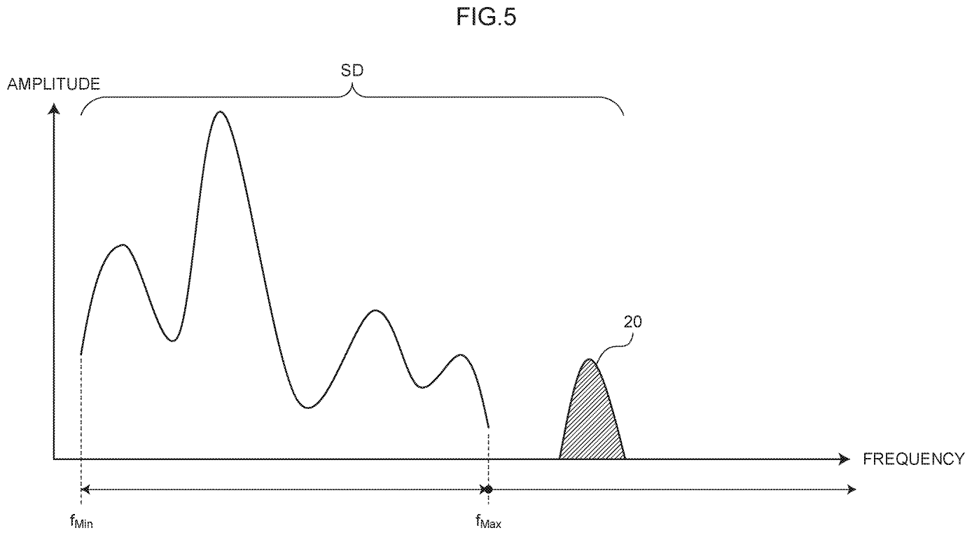

FIG. 5 is a graph illustrating an example of unique data. By superimposing unique data 20 generated, on a piece of content SD, the data combination unit 135 generates a piece of content SD including the unique data 20. That is, the generated piece of content SD is audio data including audio data in an audible frequency band (audio data included in the original piece of content SD) and audio data including audio data (the unique data 20) in a non-audible frequency band. FIG. 5 is a graph depicting an example of the piece of content SD including the unique data 20 and is an example of a waveform obtained by Fourier transform, with the horizontal axis representing frequency and the vertical axis representing amplitude. In the example of FIG. 5, the piece of content SD is audio data including audio data having frequencies in a range from fMin to fMax (an audible range) and audio data having frequencies greater than fMax (a non-inaudible range). The audio data in the range from fMin to fMax are the audio data included in the original piece of content SD and the audio data having frequencies greater than fMax are the unique data 20. However, the waveform in FIG. 5 is just an example.

In this embodiment, for example, in a case where unique data 20 are not included in a piece of content SD acquired by the management apparatus 100 from a user terminal 300, the management apparatus 100 superimposes unique data 20 on the piece of content SD and generates a piece of composite content SE by combining that piece of content SD with content data. This processing by the management apparatus 100 will be specifically described hereinafter.

### Processing of Management Apparatus

The processing of the management apparatus 100 will be described next.

### Acquisition of Content

The acquisition unit 131 acquires a piece of content SD (a piece of target content) from a user terminal 300. As described above, in this embodiment, because user information is transmitted with the piece of content SD, the acquisition unit 131 acquires the piece of content SD and also the user information indicating a user U who transmitted the piece of content SD. Similarly, in this embodiment, because combining destination information is transmitted with the piece of content SD, the acquisition unit 131 acquires the piece of content SD and also the combining destination information indicating content data (a piece of composite content SE that is a combining destination) with which the piece of content SD is to be combined.

### Determination of Whether Unique Data are Included

The determination unit 132 determines whether or not a piece of content SD (a piece of target content) acquired by the acquisition unit 131 includes unique data 20. For example, in a case where audio data in a predetermined frequency band (audio data in a non-audible range in this example) are included in the piece of content SD, the determination unit 132 may determine that the piece of content SD includes unique data 20, and in a case where audio data in the predetermined frequency band (audio data in the non-audible range in this example) are not included in the piece of content SD, the determination unit 132 may determine that the piece of content SD does not include unique data 20.

In this embodiment, the data generation unit 133, the data comparison unit 134, the data combination unit 135, and the superimposition unit 136 execute processing according to a result of determination by the determination unit 132. Their processing will be described hereinafter.

### Case Where Unique Data are Not Included

In a case where the determination unit 132 determines that a piece of content SD does not include unique data 20, the data generation unit 133 generates unique data 20. The data generation unit 133 generates unique data 20 unique to a user who is the creator of the piece of content SD (in this example, unique data 20 having a waveform different from those of unique data 20 for identifying other creators).

In a case where it is determined that the piece of content SD does not include unique data 20, the data combination unit 135 identifies a layer L of the piece of content SD and superimposes the unique data 20 generated by the data generation unit 133 on the piece of content SD in correspondence with the layer L. That is, the data combination unit 135 generates, as a piece of content SD, audio data in which the unique data 20 have been superimposed on the piece of content SD acquired by the acquisition unit 131. The layer L of the piece of content SD indicates the order in which the piece of content SD was combined with content data (a piece of composite content SE with which the piece of content SD is to be combined), assuming that the piece of content SD was combined with the content data. The layer L of the piece of content SD may be identified by any method, but in this embodiment, the layer L of the piece of content SD is identified on the basis of combining destination information associated with the piece of content SD. That is, for example, as illustrated in FIG. 4, in a case where the piece of content SD3 is acquired and its combining destination information indicates the piece of composite content SE of the pieces of content SD1 and SD2, the layer L of the piece of content SD3 is the layer L3 (third). By superimposing the unique data 20 in correspondence with the layers L as described above, even in a case where a piece of composite content SE is generated by combining a plurality of pieces of content SD, unique data 20 of each piece of content SD are able to be appropriately recognized because the layer L of each piece of content SD is different.

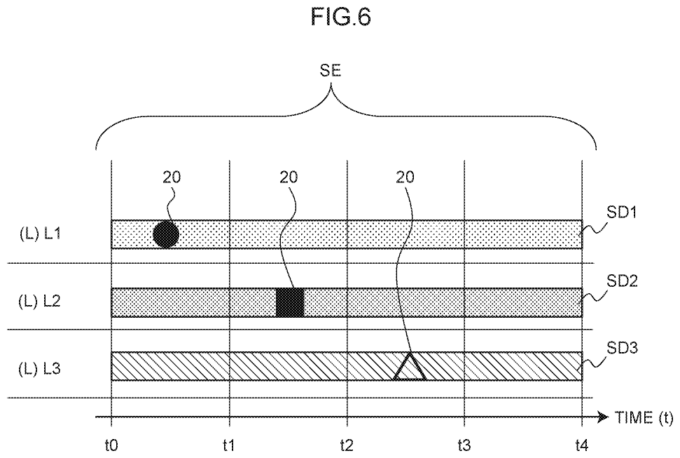

FIG. 6 is a schematic diagram illustrating an example of a method of superimposing unique data. The data combination unit 135 may superimpose unique data 20 in correspondence with a layer L by any method based on the layer L of a piece of content SD, but the data combination unit 135 according to the embodiment embeds the unique data 20 at a time position corresponding to the layer L. Specifically, a data combination unit 336 superimposes the unique data 20 on a time slot corresponding to the layer L, the time slot being in the entire time slot of the piece of content SD (from the start to the end of the piece of content SD). That is, the data combination unit 336 divides the entire time slot of the piece of content SD into a plurality of time slots, extracts a time slot corresponding to the layer L (order) of the piece of content SD from the plurality of time slots, and superimposes the unique data 20 on the extracted time slot. Even in a case where a plurality of pieces of content SD are combined to generate a piece of composite content SE, superimposing unique data 20 on a time slot corresponding to the layer L as described above enables unique data 20 of each piece of content SD to be appropriately recognized because time slots during which the unique data 20 of the respective pieces of content SD are reproduced differ from one another.

In the example of FIG. 6, the entire time slots of the pieces of content SD1, SD2, and SD3 are from a time t0 to a time t4. In the example of FIG. 6, because the layer L of the piece of content SD1 is L1 (first), the data combination unit 336 superimposes the unique data 20 of the piece of content SD1 on the time slot from the time t0 to the time t1, which is a part of the entire time slot from the time t0 to the time t4 of the piece of content SD1. Similarly, in the example of FIG. 6, the data combination unit 336 superimposes the unique data 20 of the piece of content SD2 on the time slot from the time t1 to the time t2 of the piece of content SD2 and superimposes the unique data 20 of the piece of content SD3 on the time slot from the time t2 to the time t3 of the piece of content SD3. The method of superimposing the unique data 20 in FIG. 6 is just an example.

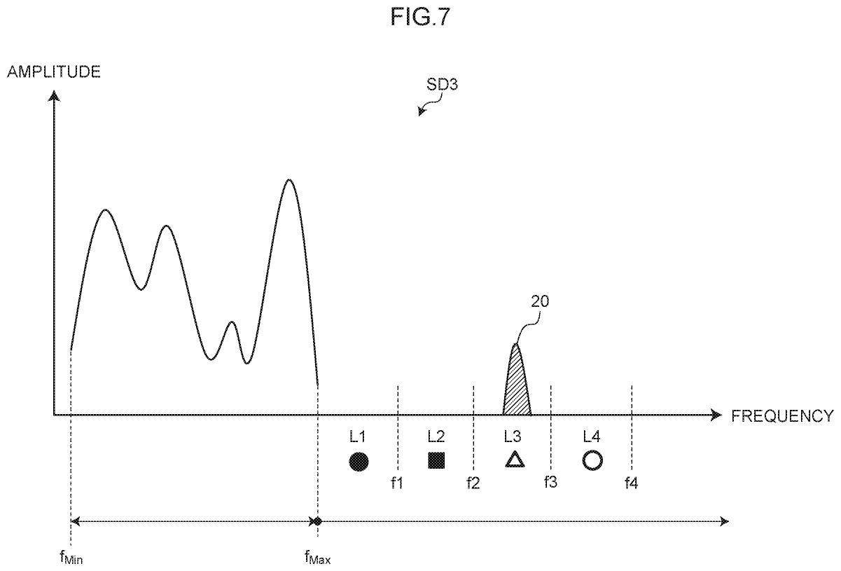

FIG. 7 is a schematic diagram illustrating another example of the method of superimposing unique data. The data combination unit 135 may embed unique data 20, as audio data having frequencies in a frequency band corresponding to the layer L of a piece of content SD, in the piece of content SD. Specifically, the data combination unit 135 divides a non-audible frequency band (for example, a frequency band less than 20 Hz or a frequency band greater than 20 kHz) into a plurality of frequency bands, extracts, from the plurality of frequency bands, a frequency band corresponding to the layer L (order) of the piece of content SD, and superimposes the unique data 20, as audio data having frequencies in the extracted frequency band, on the piece of content SD. As described above, because the unique data 20 are the audio data in the frequency band corresponding to the layer L, even in a case where a plurality of pieces of content SD are combined to generate a piece of composite content SE, the unique data 20 of each piece of content SD are able to be appropriately recognized because the frequency bands of the unique data 20 of the respective pieces of content SD differ from one another.

In the example of FIG. 7, frequencies higher than a frequency fMax are set as the non-audible frequency band, and the non-audible frequency band is divided into a frequency band from the frequency fMax to a frequency f1, a frequency band from the frequency f1 to a frequency f2, a frequency band from the frequency f2 to a frequency f3, and a frequency band from the frequency f3 to a frequency f4. Because the layer L of the piece of content SD3 is the layer L3 (third), the data combination unit 336 superimposes, on the piece of content SD3, unique data 20 having frequencies in the frequency band from the frequency f2 to the frequency f3. The method of superimposing the unique data 20 in FIG. 7 is just an example.

In a case where it is determined that a piece of content SD does not include unique data 20, the data comparison unit 134 permits combination of the piece of content SD on which unique data 20 have been superimposed with content data (a piece of composite content SE with which the piece of content SD is to be combined). In other words, the data comparison unit 134 permits uploading of, as a piece of content SD included in a piece of composite content SE, the piece of content SD on which the unique data 20 have been superimposed. The superimposition unit 136 generates a piece of composite content SE by combining the piece of content SD on which the unique data 20 have been superimposed, with the content data indicated by the combining destination information. That is, the superimposition unit 136 uploads the piece of content SD on which the unique data 20 have been superimposed, as the piece of content SD included in the piece of composite content SE.

As described above, with respect to a piece of content SD in which unique data 20 have not been embedded, combining the piece of content SD into a piece of composite content SE after embedding the unique data 20 in the piece of content SD enables the creator of the piece of content SD to be appropriately recognized.

### Case Where Unique Data are Included

In a case where it is determined that a piece of content SD includes unique data 20, the determination unit 132 determines whether the creator indicated by the unique data 20 matches the user U who transmitted the piece of content SD. The determination unit 132 determines whether the creator indicated by the unique data 20 included in the piece of content SD (that is, the creator of the piece of content SD) matches the user U indicated by user information associated with the piece of content SD, that is, whether the creator and the user U are the same person. This determination may be made by any method, but for example, a table indicating correspondence relations between unique data 20 and users U may be set beforehand and the determination unit 132 may extract, as the creator, the user U corresponding to the unique data 20 included in the piece of content SD, from the table. The determination unit 132 may then determine whether the extracted creator matches the user U indicated by the user information. Furthermore, for example, the determination unit 132 may acquire unique data 20 of the user U indicated by the user information, compare the unique data 20 of the user U with the unique data 20 included in the piece of content SD by waveform analysis, and thereby determine whether the creator matches the user U indicated by the user information.

### Case Where Creator and User Do Not Match

In a case where the determination unit 132 determines that the creator indicated by the unique data 20 does not match the user U who transmitted the piece of content SD, the data comparison unit 134 does not permit the piece of content SD to be combined with the content data (the piece of composite content SE with which the piece of content SD is to be combined). That is, the data comparison unit 134 does not permit the piece of content SD to be uploaded as a piece of content SD included in a piece of composite content SE. The superimposition unit 136 thus does not combine the piece of content SD with the content data indicated by the combining destination information (the piece of composite content SE with which the piece of content SD is to be combined) and does not upload the piece of content SD as the piece of content SD included in the piece of composite content SE. In this case, the piece of content SD includes the unique data 20, the data generation unit 133 thus does not generate unique data 20 for this piece of content SD, and the data combination unit 135 thus does not newly embed unique data 20 in this piece of content SD.

As described above, in the case where the creator indicated by the unique data 20 does not match the user U who transmitted the piece of content SD, not permitting the piece of content SD to be combined (uploaded) prevents the piece of content SD from being treated as a work of a user who is not the creator.

### Case Where Creator and User Match

In a case where the creator indicated by the unique data 20 matches the user U who transmitted the piece of content SD, the determination unit 132 determines whether the unique data 20 have been superimposed in correspondence with the layer L of the piece of content SD. For example, in a case where the time slot in which the unique data 20 have been embedded matches the time slot corresponding to the layer L of the piece of content SD, the determination unit 132 determines that the unique data 20 have been superimposed in correspondence with the layer L of the piece of content SD. On the contrary, in a case where the time slot in which the unique data 20 have been embedded does not match the time slot corresponding to the layer L of the piece of content SD, the determination unit 132 determines that the unique data 20 have not been superimposed in correspondence with the layer L of the piece of content SD (that is, the unique data 20 have been superimposed not in correspondence with the layer L of the piece of content SD). Furthermore, for example, in a case where the frequency band of the unique data 20 matches the frequency band corresponding to the layer L of the piece of content SD, the determination unit 132 determines that the unique data 20 have been superimposed in correspondence with the layer L of the piece of content SD. On the contrary, in a case where the frequency band of the unique data 20 does not match the frequency band corresponding to the layer L of the piece of content SD, the determination unit 132 determines that the unique data 20 have not been superimposed in correspondence with the layer L of the piece of content SD (that is, the unique data 20 have been superimposed not in correspondence with the layer L of the piece of content SD).

Case Where Unique Data Have Been Superimposed in Correspondence with Layer of Content

In a case where the unique data 20 have been superimposed in correspondence with the layer L of the piece of content SD, the data comparison unit 134 permits the piece of content SD to be combined with the content data (the piece of composite content SE with which the piece of content SD is to be combined). That is, the data comparison unit 134 permits the piece of content SD to be uploaded as a piece of content SD included in a piece of composite content SE. Therefore, the superimposition unit 136 combines the piece of content SD with the content data indicated by the combining destination information (the piece of composite content SE with which the piece of content SD is to be combined). In other words, the superimposition unit 136 uploads the piece of content SD as the piece of content SD included in the piece of composite content SE. In this case, the piece of content SD includes the unique data 20, the data generation unit 133 thus does not generate unique data 20 for this piece of content SD, and the data combination unit 135 thus does not newly embed unique data 20 in the piece of content SD.

As described above, in the case where the creator indicated by the unique data 20 matches the user U who transmitted the piece of content SD, permitting the piece of content SD to be combined (uploaded) prevents the piece of content SD from being treated as a work of a user U who is not the creator. Furthermore, in a case where the unique data 20 have been embedded at the position corresponding to the layer L, the unique data 20 of each piece of content SD are able to be appropriately recognized by uploading the piece of content SD as is, without newly embedding unique data 20.

### Case Where Unique Data Have Been Superimposed on Time Slot Corresponding to Layer of Content

For example, in a case where the unique data 20 of the piece of content SD3 have been embedded in the time slot from the time t2 to the time t3 corresponding to the layer L3 of the piece of content SD3, the data comparison unit 134 permits the piece of content SD to be combined with the content data (the piece of composite content SE with which the piece of content SD3 is to be combined). That is, the data comparison unit 134 permits the piece of content SD to be uploaded as a piece of content SD included in a piece of composite content SE. Therefore, the superimposition unit 136 combines the piece of content SD with the content data indicated by the combining destination information (the piece of composite content SE with which the piece of content SD is to be combined). In other words, the superimposition unit 136 uploads the piece of content SD as the piece of content SD included in the piece of composite content SE. In this case, the piece of content SD includes the unique data 20, the data generation unit 133 thus does not generate unique data 20 for this piece of content SD, and the data combination unit 135 thus does not newly embed unique data 20 in the piece of content SD.

As described above, in the case where the creator indicated by the unique data 20 matches the user U who transmitted the piece of content SD, permitting the piece of content SD to be combined (uploaded) prevents the piece of content SD from being treated as a work of a user U who is not the creator. Furthermore, in a case where the unique data 20 have been embedded at the position corresponding to the layer L, the unique data 20 of each piece of content SD are able to be appropriately recognized by uploading the piece of content SD as is, without newly embedding unique data 20.

Case Where Unique Data Have Been Superimposed Not in Correspondence with Layer of Content

In a case where the unique data 20 have been superimposed not in correspondence with the layer L of the piece of content SD (for example, in a case where the unique data 20 of the piece of content SD3 have been embedded in a time slot different from the time slot from the time t2 to the time t3 corresponding to the layer L3 of the piece of content SD3), the data combination unit 135 re-superimposes the unique data 20 in correspondence with the layer L of the piece of content SD. That is, in this case, the data combination unit 135 deletes the unique data 20 included in the piece of content SD from the piece of content SD, and superimposes the unique data 20 on the piece of content SD in correspondence with the layer L of the piece of content SD. The data comparison unit 134 then permits the piece of content SD, on which the unique data 20 have been re-superimposed, to be combined with the content data (the piece of composite content SE with which the piece of content SD is to be combined). In other words, the data comparison unit 134 permits the piece of content SD, on which the unique data 20 have been re-superimposed, to be uploaded as a piece of content SD included in a piece of composite content SE. The superimposition unit 136 generates the piece of composite content SE by combining the piece of content SD, on which the unique data 20 have been re-superimposed, with the content data indicated by the combining destination information (the piece of composite content DE with which the piece of content SD is to be combined). That is, the superimposition unit 136 uploads the piece of content SD, on which the unique data 20 have been re-superimposed, as the piece of content SD included in the piece of composite content SE.

As described above, in a case where the creator indicated by the unique data 20 matches the user U who transmitted the piece of content SD but the unique data 20 have not been embedded at the position corresponding to the layer L, re-embedding the unique data 20 at the position corresponding to the layer L and uploading the piece of content SD re-embedded with the unique data 20 enables the unique data 20 of each piece of content SD to be appropriately recognized.

### Processing Flow

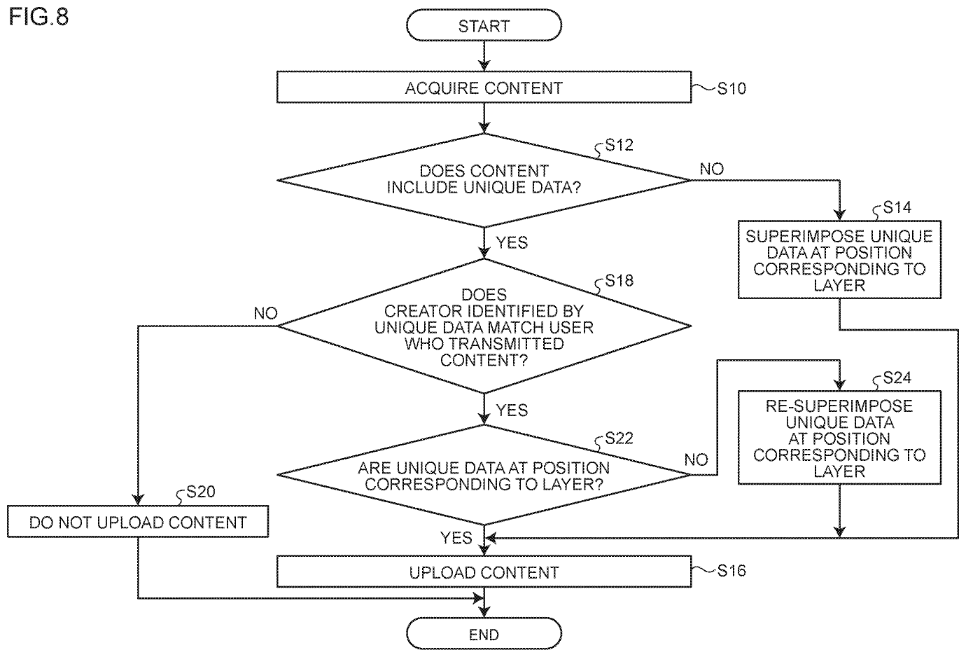

A processing flow according to the embodiment will be described next. FIG. 8 is a flowchart illustrating a processing flow of the management apparatus according to the first embodiment. As illustrated in FIG. 8, the management apparatus 100 acquires, by means of the acquisition unit 131, a piece of content SD from a user terminal 300 (Step S10). The determination unit 132 determines whether the piece of content SD acquired by the acquisition unit 131 includes unique data 20 (Step S12). In a case where the piece of content SD does not include unique data 20 (Step S12; No), the data generation unit 133 generates unique data 20, and the data combination unit 135 superimposes the unique data 20 generated, at a position corresponding to a layer L of the piece of content SD (Step S14). The data comparison unit 134 permits the piece of content SD to be uploaded (to be combined with content data), and the superimposition unit 136 uploads the piece of content SD (combines the piece of content SD with the content data) (Step S16). On the contrary, at Step S12, in a case where the piece of content SD includes unique data 20 (Step S12; Yes), the determination unit 132 determines whether a creator identified by the unique data 20 already included in the piece of content SD matches a user U (a user U indicated by user information) who transmitted the piece of content SD (Step S18). In a case where the creator does not match the user U (Step S18; No), the data comparison unit 134 does not permit the piece of content SD to be uploaded (to be combined with the content data), and the superimposition unit 136 does not upload the piece of content SD (does not combine the piece of content SD with the content data) (Step S20).

At Step S18, in a case where the creator matches the user U (Step S18; Yes), the determination unit 132 determines whether the unique data 20 already included in the piece of content SD have been embedded at the position corresponding to the layer L of the piece of content SD (Step S22). In a case where the unique data 20 have been embedded at the position corresponding to the layer L of the piece of content SD (Step S22; Yes), the flow advances to Step S16, the data comparison unit 134 permits the piece of content SD to be uploaded (to be combined with the content data), and the superimposition unit 136 uploads the piece of content SD (combines the piece of content SD with the content data). On the contrary, in a case where the unique data 20 have not been embedded at the position corresponding to the layer L of the piece of content SD (Step S22; No), the data combination unit 135 re-superimposes the unique data 20 at the position corresponding to the layer L of the piece of content SD (Step S24) and proceeds to Step S16. When Step S16 or Step S20 is executed, the processing ends.

### Second Embodiment

A second embodiment will be described next. The second embodiment is different from the first embodiment in that a system includes an identification device 400 that identifies, from a piece of composite content SE, creator information of a piece of content SD included in the piece of composite content SE. Description of any part according to the second embodiment and configured in the same way as the first embodiment will be omitted.

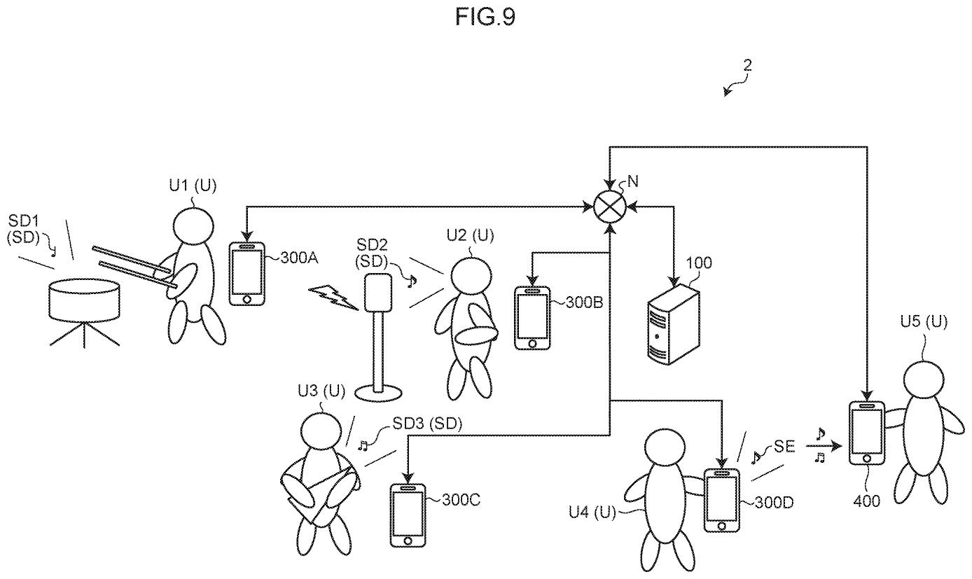

FIG. 9 is a schematic diagram of a data system according to the second embodiment. As illustrated in FIG. 9, a data system 2 according to the second embodiment includes a management apparatus 100, user terminals 300, and the identification device 400. The management apparatus 100, the user terminals 300, and the identification device 400 communicate with each other via a network N.

### Identification Device

The identification device 400 is a device that identifies, on the basis of a piece of composite content SE, creator information of a piece of content SD included in the piece of composite content SE. The identification device 400 may be any device. For example, the identification device 400 may be an information processing device, such as a smartphone, a tablet terminal, a wearable terminal, a mobile phone, or a PDA. FIG. 9 illustrates an example of a case where the identification device 400 is a smartphone.

### Configuration of Identification Device

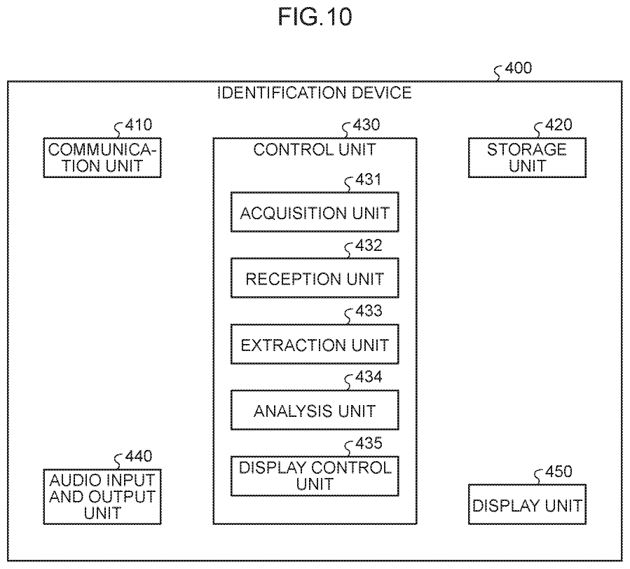

FIG. 10 is a schematic block diagram of an identification device according to the second embodiment. As illustrated in FIG. 10, the identification device 400 includes a communication unit 410, a storage unit 420, a control unit 430, an audio input and output unit 440, and a display unit 450.

### Communication Unit

The communication unit 410 is a communication module through which the identification device 400 communicates with an external device. The communication unit 410 transmits and receives various data to and from the external device via wireless communication or wired communication. In the case of wireless communication, the communication unit 410 may include communication processing circuitry, such as a communication antenna, an RF circuit, and/or a wireless LAN card. In the case of wired communication, for example, the communication unit 410 may include an NIC equipped with a wired LAN terminal, a transmission circuit, and/or other communication processing circuitry.

### Storage Unit

The storage unit 420 is a storage device that stores various information. The storage unit 420 includes a main storage device, and an auxiliary storage device. The main storage device may be implemented by, for example, a semiconductor memory element, such as a RAM, a ROM, or a flash memory. The auxiliary storage device may be implemented by, for example, a hard disk, an SSD, or an optical disk.

### Audio Input and Output Unit

The audio input and output unit 440 inputs and outputs various audio. That is, the audio input and output unit 440 has a microphone function and a speaker function. For example, the audio input and output unit 440 may output audio of a piece of content SD. The audio input and output unit 440 may receive input of audio of content data through a microphone.

### Display Unit

The display unit 450 displays various information. For example, the display unit 450 may display a GUI for executing various processing of the identification device 400. The display unit 450 may be implemented by a liquid crystal display, an organic EL display, or a micro LED display.

### Control Unit

The control unit 430 is a controller that governs and controls the identification device 400. The control unit 430 is implemented by, for example, a CPU or an MPU executing various programs stored in the storage unit 420, with a RAM serving as a work area. The control unit 430 may be implemented by, for example, an integrated circuit, such as an ASIC or an FPGA.

As illustrated in FIG. 10, the control unit 430 includes an acquisition unit 431, a reception unit 432, an extraction unit 433, an analysis unit 434, and a display control unit 435. By reading and executing programs (software) from the storage unit 420, the control unit 430 implements their functions and executes processing thereof. The functions of the control unit 430 may be implemented by electronic circuits. The control unit 430 may execute the processing by means of a single CPU, or may include a plurality of CPUs and the plurality of CPUs may execute the processing in parallel.

### Processing of Identification Device

Processing performed by the identification device 400 will be described hereinafter.

The acquisition unit 431 controls the audio input and output unit 440 that is a microphone, to cause the audio input and output unit 440 to acquire (collect) a piece of composite content SE reproduced by an external device. The piece of composite content SE may be reproduced by any device, and is reproduced by a user terminal 300D in the example of FIG. 9. That is, in this embodiment, the acquisition unit 431 may receive a piece of composite content SE itself, which is audio data, or acquire a piece of composite content SE that is analog-reproduced by a speaker not illustrated in the figure, the speaker being different from the audio input and output unit 440, the piece of composite content SE being collected by the microphone.

The reception unit 432 receives an analysis request from a user U5 who is a user U of the identification device 400, the analysis request being a request to identify creator information from the piece of composite content SE. The analysis request may be received by any method. For example, the reception unit 432 may cause the display unit 450 of the identification device 400 to display an analysis request reception screen and receive touch operation performed by the user U5 as the analysis request from the user U5.

On the basis of a piece of composite content SE acquired (collected) by the acquisition unit 431, the extraction unit 433 extracts unique data 20 included in the piece of composite content SE. The unique data 20 may be extracted from the piece of composite content SE by any method. For example, the extraction unit 433 according to the embodiment extracts the unique data 20 included in the piece of composite content SE by performing filter processing on the acquired piece of composite content SE to leave only audio data in a non-audible frequency band, thereby removing audio data in an audible frequency band.

The analysis unit 434 identifies creator information from unique data 20 extracted by the extraction unit 433, for each layer L of a piece of composite content SE (for each piece of content SD included in the piece of composite content SE). The creator information for each layer L of the piece of composite content SE may be identified from the unique data 20 by any method. For example, the analysis unit 434 according to the embodiment may acquire a waveform of the unique data 20 by performing frequency analysis of the unique data 20 extracted. In this case, a table indicating correspondence relations between waveforms and creators has been set beforehand, and the analysis unit 434 identifies the creator corresponding to the waveform acquired, as the creator information. The unique data 20 of the pieces of content SD included in the piece of composite content SE have been embedded at positions different from one another according to the layers L of the pieces of content SD. Therefore, the analysis unit 434 is able to individually extract the unique data 20 of each piece of content SD from the piece of composite content SE acquired (collected) by the acquisition unit 431 and identify the creator for each piece of content SD.

The display control unit 435 causes the display unit 450 to display the creator information identified by the analysis unit 434. The creator information may be displayed by any method. For example, the display control unit 435 according to the embodiment causes the display unit 450 to display a tree diagram depicting the creator information for each piece of content SD. Furthermore, for example, the display control unit 435 may cause the display unit 450 to display a table listing the creator information for the respective pieces of content SD.

As described above, the identification device 400 according to the embodiment calculates creator information for each piece of content SD from a piece of composite content SE. According to the present disclosure, creator information for each piece of content SD is able to be calculated from a piece of composite content SE that has been reproduced.

### Effects

As described above, the data system 1 according to the present disclosure includes: the acquisition unit 131 that acquires a piece of target content to be combined into a piece of composite content SE in which a plurality of pieces of content SD that are music data have been hierarchically combined; the data generation unit 133 that generates unique data 20 that are audio data for identifying a creator of the piece of target content; and the data combination unit 135 that superimposes the unique data 20 on the piece of target content in correspondence with a layer L of the piece of target content for combination of the piece of target content into the piece of composite content SE. According to the present disclosure, the creators of the pieces of content SD are able to be identified. Embedding unique data as audio data enables copyright information to be included in analog audio itself reproduced from the audio data.

Furthermore, the data system 1 according to the present disclosure further includes: the determination unit 132 that determines whether the piece of target content includes unique data 20; and the data comparison unit 134 that determines, on the basis of a result of determination by the determination unit 132, whether to permit the piece of target content to be combined into the piece of composite content SE. In a case where the piece of target content does not include unique data 20, the data combination unit 135 superimposes unique data 20 on the piece of target content in correspondence with the layer L of the piece of target content and the data comparison unit 134 permits combination of the piece of target content on which the unique data 20 have been superimposed. In a case where the piece of target content includes unique data 20 but a creator indicated by the unique data 20 is different from a user U who transmitted the piece of target content, the data comparison unit 134 does not permit the combination of the piece of target content. In a case where the piece of target content includes unique data 20, a creator indicated by the unique data 20 and the user U who transmitted the piece of target content are the same, and the unique data 20 have been superimposed in correspondence with the layer of the piece of target content, the data comparison unit 134 permits the combination of the piece of target content. In a case where the piece of target content includes unique data 20, a creator indicated by the unique data 20 and the user U who transmitted the piece of target content are the same, and the unique data 20 have been superimposed not in correspondence with the layer L of the piece of target content, the data combination unit 135 re-superimposes the unique data 20 in correspondence with the layer L of the piece of target content and the data comparison unit 134 permits the combination of the piece of target content on which the unique data 20 have been re-superimposed. According to the present disclosure, enabling the creator of a piece of content SD to be identified and stopping upload in a case where when a user U attempting to perform the upload is different from the creator of the piece of content SD to be uploaded prevent unauthorized upload of the piece of content SD by the user U other than the creator of the piece of content SD.

The identification device 400 according to the present disclosure includes: the acquisition unit 431 that acquires a piece of composite content SE generated by the data system 1; the extraction unit 433 that extracts unique data 20 of a piece of content SD included in the piece of composite content SE, from the piece of composite content SE acquired; and the analysis unit 434 that identifies creator information of the piece of content SD from the unique data 20 extracted. According to the present disclosure, creator information for each layer L of the piece of composite content SE is able to be calculated from the piece of composite content SE. Furthermore, not only in a case where a piece of composite content SE is acquired via communication, but also in a case where a piece of composite content SE reproduced by any speaker is acquired through a microphone, the identification device 400 according to the present disclosure is able to calculate copyright information.

A method of controlling the data system 1 according to the present disclosure includes: a step of acquiring a piece of target content to be combined into a piece of composite content SE in which a plurality of pieces of content SD that are music data have been hierarchically combined; a step of generating unique data 20 that are audio data for identifying a creator of the piece of target content; and a step of superimposing the unique data 20 on the piece of target content in correspondence with a layer L of the piece of target content for combination of the piece of target content into the piece of composite content SE. According to the present disclosure, the creators of the pieces of content SD are able to be identified.

A program according to the present disclosure causes a computer to execute: a step of acquiring a piece of target content to be combined into a piece of composite content SE in which a plurality of pieces of content SD that are music data have been hierarchically combined; a step of generating unique data 20 that are audio data for identifying a creator of the piece of target content; and a step of superimposing the unique data 20 on the piece of target content in correspondence with a layer L of the piece of target content for combination of the piece of target content into the piece of composite content SE. According to the present disclosure, the creators of the pieces of content SD are able to be identified.

An embodiment according to the present disclosure enables provision of a data system, an identification device, a data system control method, and a program that enable creators of content to be identified.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A data system, comprising:
an acquisition unit that acquires a piece of target content to be combined into a piece of composite content in which a plurality of pieces of content that are music data have been hierarchically combined;
a data generation unit that generates unique data that are audio data for identifying a creator of the piece of target content; and
a data combination unit that superimposes the unique data on the piece of target content in correspondence with a layer of the piece of target content for combination of the piece of target content into the piece of composite content.

2. The data system according to claim 1, further comprising:
a determination unit that determines whether the piece of target content includes the unique data; and
a data comparison unit that determines, on the basis of a result of determination by the determination unit, whether to permit the piece of target content to be combined into the piece of composite content, wherein
in a case where the piece of target content does not include the unique data, the data combination unit superimposes the unique data on the piece of target content in correspondence with the layer of the piece of target content and the data comparison unit permits combination of the piece of target content on which the unique data have been superimposed,
in a case where the piece of target content includes the unique data but the creator indicated by the unique data is different from a user who transmitted the piece of target content, the data comparison unit does not permit the combination of the piece of target content,
in a case where the piece of target content includes the unique data, the creator indicated by the unique data and the user who transmitted the piece of target content are the same, and the unique data have been superimposed in correspondence with the layer of the piece of target content, the data comparison unit permits the combination of the piece of target content, and
in a case where the piece of target content includes the unique data, the creator indicated by the unique data and the user who transmitted the piece of target content are the same, and the unique data have been superimposed not in correspondence with the layer of the piece of target content, the data combination unit re-superimposes the unique data in correspondence with the layer of the piece of target content and the data comparison unit permits the combination of the piece of target content on which the unique data have been re-superimposed.

3. An identification device, comprising:
an acquisition unit that acquires the piece of composite content generated by the data system according to claim 1;
an extraction unit that extracts the unique data of the piece of content included in the piece of composite content, from the piece of composite content acquired; and
an analysis unit that identifies creator information of the piece of content from the unique data extracted.

4. A data system control method, including:
a step of acquiring a piece of target content to be combined into a piece of composite content in which a plurality of pieces of content that are music data have been hierarchically combined;
a step of generating unique data that are audio data for identifying a creator of the piece of target content; and
a step of superimposing the unique data on the piece of target content in correspondence with a layer of the piece of target content for combination of the piece of target content into the piece of composite content.

5. A non-transitory computer-readable storage medium storing a program causing a computer to execute:
a step of acquiring a piece of target content to be combined into a piece of composite content in which a plurality of pieces of content that are music data have been hierarchically combined;
a step of generating unique data that are audio data for identifying a creator of the piece of target content; and
a step of superimposing the unique data on the piece of target content in correspondence with a layer of the piece of target content for combination of the piece of target content into the piece of composite content.
